(19) United States
(12) Patent Application Publication
(10) Pub. No.: US 2012/0320583 A1
(43) Pub. Date: Dec. 20, 2012

(54) LIGHTING APPARATUS

(75) Inventors: Ties Van Bommel, Horst (NL); Rifat Ata Mustafa Hikmet, Eindhoven (NL); Yongfeng Ni, Waalre (NL)

(73) Assignee: KONINKLIJKE PHILIPS ELECTRONICS, N.V., EINDHOVEN (NL)

(21) Appl. No.: 13/581,420

(22) PCT Filed: Feb. 4, 2011
(86) PCT No.: PCT/IB2011/050484

§ 371 Date: Aug. 27, 2012

(30) Foreign Application Priority Data
Mar. 1, 2010 (EP) 10155003.6

(51) Int. Cl. F21V 13/12

(52) U.S. Cl. 362/235

(57) ABSTRACT

The invention relates to a lighting apparatus (1). A first light device (52) comprises a first light source (2) for generating a first light beam (3) and a light emanating element (6) from which the first light beam (3) emanates. A second light device (53) with a second light source (4) generates a second light beam (5) being directed to the light emanating element (6) of the first light device (52), wherein the light emanating element (6) is adapted to redirect the second light beam (5) such that the redirected second light beam (7) emanates from the light emanating element (6). Since the first light beam (5) and the redirected second light beam (7) emanate from the light emanating element (6), both light beams appear to originate from the same location. The probability of generating selective shadowing effects can therefore be reduced, in particular, selective shadowing effects can be eliminated.

### FIELD OF THE INVENTION

The invention relates to a lighting apparatus and a lighting method.

### BACKGROUND OF THE INVENTION

EP 1 898 144 A2 discloses a lighting apparatus comprising several light emitting diodes which are connected with and distributed over a heatsink. The several light emitting diodes generate several light beams which are generally differently blocked, if an obstruction is present in the light paths of the several light beams. This different blocking for different light beams leads to selective shadowing effects.

### SUMMARY OF THE INVENTION

It is an object of the present invention to provide a lighting apparatus comprising several light sources, wherein selective shadowing effects can be reduced. It is a further object of the present invention to provide a corresponding lighting method. In a first object of the present invention a lighting apparatus is presented, wherein the lighting apparatus comprises:

a first light device comprising a first light source for generating a first light beam and a light emanating element from which the first light beam emanates,

a second light device comprising a second light source for generating a second light beam,

wherein the first light device and the second light device are arranged to direct the second light beam to the light emanating element of the first light device, wherein the light emanating element is adapted to redirect the second light beam such that the redirected second light beam emanates from the light emanating element.

Selective shadowing effects in an illumination pattern generated by two light sources are more likely, if the two light sources are arranged at different locations as it is generally the case. Since the first light device and the second light device are arranged to direct the second light beam to the light emanating element of the first light device, wherein the light emanating element is adapted to redirect the second light beam such that the redirected second light beam emanates from the light emanating element, and since also the first light beam emanates from the light emanating element, both light beams appear to originate from the same light emanating element, i.e. from the same location. The probability of generating selective shadowing effects can therefore be reduced, in particular, selective shadowing effects can be eliminated.

The light emanating element can be a part of the first light source, for example, an outer part, in particular, an outer surface, of the first light source, through which the first light beam leaves the first light source, wherein this outer part, in particular, the outer surface, of the first light source is preferentially reflective for redirecting the second light beam. The light emanating element can also be integrated into this outer part, for example, by embossing and/or imprinting. However, the light emanating element can also be a part being separate from the first light source, for example, the light emanating element can be located on the outer part of the first light source, through which the first light beam leaves the first light source and which may or may not be reflective to the second light beam. The second light beam can be oriented perpendicular, parallel or transverse to an outer surface of the first light source, through which the first light beam leaves the first light device.

The redirection of the second light beam by the light emanating element includes any direction change which can be induced by the light emanating element. For example, the light emanating element can redirect the second light beam, i.e. induce a direction change of the second light beam, by reflection, diffusion, refraction, diffraction, converting the second light beam into another kind of light with a propagation direction being different to the propagation direction of the second light beam, et cetera.

The first light beam and the redirected second light beam emanate from the light emanating element. This does not mean that the first light beam and the redirected second light beam have to be generated in the light emanating element, but it means that the first light beam and the second light beam both come from the light emanating element. For example, the first light beam can traverse the light emanating element, wherein after having traversed the light emanating element the first light beam comes from the light emanating element, and the second light beam can be redirected, in particular, reflected, by the light emanating element, wherein after having been redirected by the light emanating element also the redirected second light beam comes from the light emanating element.

The lighting apparatus is preferentially adapted to be used in decorative lighting, shop lighting and atmosphere creation. The lighting apparatus may be a retrofit lamp, which might be used in, for example, torches, toys and/or luminaires.

The first light device and the second light device provide preferentially different kinds of light. The lighting apparatus is therefore preferentially a hybrid lighting apparatus.

It is preferred that the first light source is a light emitting diode and the second light source is a laser. The laser is preferentially a laser diode. This allows the lighting apparatus to generate, for example, a high intensity laser illumination on a background illumination generated by the light emitting diode.

The light emanating element can be adapted to redirect the second light beam by reflecting the second light beam such that the reflected second light beam emanates from the light emanating element. In particular, as already mentioned above, the light emanating element can at least partly be formed by an outer surface of the first light source through which the first light beam leaves the first light source, wherein this outer surface can be reflective to the second light beam for redirecting the same.

The light emanating element can have any size. For example, it can cover a complete outer part of the first light source through which the first light beam leaves the first light source, it can cover only a part of this outer part or it can be larger than this outer part, i.e. it can protrude over the edges of this outer part. The light emanating element may also have any thickness. Moreover, the light emanating element has a surface met by the second light beam, which can have any surface structure, i.e. this surface may have a flat surface, a rough surface or comprise another desired shape.

It is further preferred that the light emanating element is adapted to redirect the second light beam by reflecting the second light beam for generating a reflection pattern. This allows the lighting apparatus to generate a desired illumination pattern with reduced or without selective shadowing effects. The reflection pattern can be a speckle pattern or can comprise light spots. Also the reflection pattern can be superimposed on the illumination generated by the first light beam for generating a combined illumination pattern.

It is further preferred that the light emanating element is adapted to redirect the second light beam by diffusing the second light beam for generating a speckle pattern. The speckle pattern can be superimposed on the illumination generated by the first light beam for generating a combined illumination pattern. The diffusing element can be adapted to produce a sparkling speckle pattern.

It is further preferred that the light emanating element is adapted to redirect the second light beam by diffracting the second light beam for generating a diffraction pattern. Also the diffraction pattern can be superimposed on the illumination generated by the first light beam for generating a combined illumination pattern. The light emanating element can be adapted to generate a desired diffraction pattern with reduced or without selective shadowing effects.

It is further preferred that the light emanating element is adapted to redirect the second light beam by converting the second light beam into a third light beam having a color being different to the color of the second light beam, wherein the third light beam emanates from the light emanating element. For example, a phosphor element comprised by the light emanating element can be used for converting the wavelengths of the second light beam. This can be used to generate advanced colored effects.

It is further preferred that the second light device is adapted to generate several second light beams for being directed to the light emanating element, wherein the light emanating element is adapted to redirect the several second light beams such that the redirected several second light beams emanate from the light emanating element. The second light device can comprise one or several beam splitters and/or several second light sources like several lasers for generating several second light beams. This allows the lighting apparatus to generate an illumination pattern by overlapping several illumination patterns generated by the different light beams with a reduced probability of selective shadowing effects, in particular, without any selective shadowing effects.

It is further preferred that the first light device comprises multiple light emanating elements, wherein the first light device and the second light device are arranged to allow the first light beam to traverse the multiple light emanating elements and to allow the second light beam to be redirected by the multiple light emanating elements. This allows the lighting apparatus to redirect the second light beam by the multiple light emanating elements which can influence the second light beam differently. For example, different light emanating elements can influence the second light beam differently, wherein these different influences can generate a certain desired illumination pattern with a reduced probability of selective shadowing effects, in particular, with no selective shadowing effects at all.

The multiple light emanating elements can form a stack on an outer part of the first light source, in particular, on an outer surface of the first light source, through which the first light beam leaves the first light source, such that first light beam traverses the stack, i.e. the multiple light emanating elements. The multiple light emanating elements are preferentially partly transparent to the second light beam such that by illuminating the stack of the multiple light emanating elements, the second light beam can enter the multiple light emanating elements for allowing the multiple light emanating elements to influence the second light beam.

It is further preferred that the first light device comprises multiple light emanating elements, wherein the first light device and the second light device are adapted to allow the first light beam to traverse the multiple light emanating elements and to allow the second light beam to be selectively directed to one or several of the multiple light emanating elements. The multiple light emanating elements can be arranged side-by-side on an outer part of the first light source, in particular, on an outer surface of the first light source, through which the first light beam leaves the first light source, such that first light beam traverses the multiple light emanating elements. The multiple light emanating elements can be adapted to redirect the second light beam differently. This allows the lighting apparatus to modify the kind of redirecting the second light beam and, thus, to modify a light pattern generated by the influenced second light beam. For example, the color and/or the spatial distribution of an illumination pattern generated by the second light beam can be modified. For allowing the second light beam to be selectively directed to one or several of the multiple light emanating elements, the second light device can comprise a redirection element, which is not the light emanating element and which is adapted to selectively direct the second light beam to the one or several of the multiple light emanating elements. In addition or alternatively, the first light device can be adapted to move the one or several of the multiple light emanating elements with respect to the second light beam such that the second light beam is selectively directable to the one or several of the multiple light emanating elements.

It is further preferred that the lighting apparatus comprises a switch for switching at least one of the first light device and the second light device. The lighting apparatus may comprise a single switch for both, the first light device and the second light device, or the lighting apparatus may comprise for each of the first light device and the second light device a single switch.

In a further aspect of the present invention a lighting method is presented, wherein the lighting method comprises:

generating a first light beam by a first light source of a first light device comprising a light emanating element from which the first light beam emanates,

generating a second light beam by a second light source of a second light device,

directing the second light beam to the light emanating element of the first light device, wherein the light emanating element redirects the second light beam such that the redirected second light beam emanates from the light emanating element.

It shall be understood that the lighting apparatus of claim 1 and the lighting method of claim 14 have similar and/or identical preferred embodiments as defined in the dependent claims.

It shall be understood that a preferred embodiment of the invention can also be any combination of the dependent claims with the respective independent claim.

These and other aspects of the invention will be apparent from and elucidated with reference to the embodiments described hereinafter.

### BRIEF DESCRIPTION OF THE DRAWINGS

In the following drawings:

FIG. 1 illustrates schematically and exemplarily the generation of a selective shadowing effect by a prior art lighting apparatus,

FIG. 2 illustrates schematically and exemplarily an elimination of the selective shadowing effect,

FIG. 3 shows schematically and exemplarily an embodiment of a lighting apparatus,

FIGS. 4 to 6 illustrate schematically and exemplarily different orientations of a second light beam with respect to a first light source,

FIGS. 7 to 9 schematically and exemplarily illustrate different orientations of several second light beams with respect to a first light source,

FIGS. 10 to 12 show schematically and exemplarily different sizes of a light emanating element,

FIGS. 13 and 14 show schematically and exemplarily different shapes of an outer surface of a light emanating element,

FIGS. 15 to 18 show schematically and exemplarily different illumination patterns generated by a second light beam superimposed on a background illumination generated by a first light beam,

FIGS. 19 and 20 show schematically and exemplarily different arrangements of several light emanating elements on the first light source,

FIGS. 21 and 22 show schematically and exemplarily a further embodiment of a lighting apparatus,

FIGS. 23 and 24 show schematically and exemplarily further embodiments of a lighting apparatus

FIG. 25 shows schematically and exemplarily a structured light emanating element on the first light source,

FIGS. 26 to 29 show schematically and exemplarily further embodiments of a lighting apparatus,

FIGS. 30 to 33 show a further embodiment of a lighting apparatus, and

FIG. 34 shows a flowchart exemplarily illustrating an embodiment of a lighting method.

### DETAILED DESCRIPTION OF EMBODIMENTS

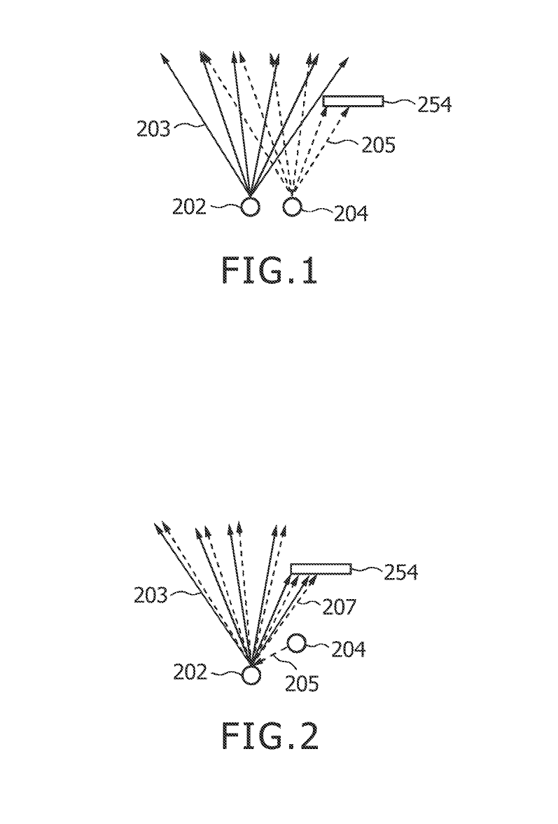

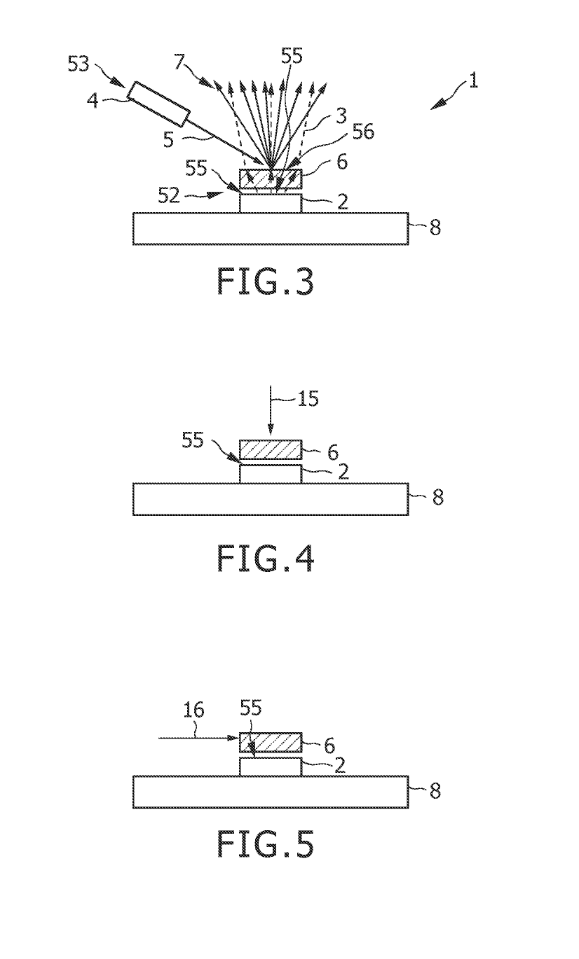

FIG. 1 schematically illustrates the generation of a selective shadowing effect, if a first light device 202 and a second light device 204 are used at different locations, wherein the first light device 202 emits a first light beam 203 and the second light device 204 emits a second light beam 205. A part of the second light beam 205 of the second light device 204 is blocked by an obstruction 254, but not the first light beam 203 of the first light device 202, thereby inducing selective shadowing effects. If the second light beam 205 of the second light device 204 is directed to the first light device 202 and if the second light beam 205 is redirected by the first light device 202 such that also the redirected second light beam 207 appears to originate from the first light device 202, the selective shadowing effects can be reduced, in particular, eliminated. This is schematically and exemplarily illustrated in FIG. 2. In FIG. 2, the first light beam 203 of the first light device 202 and the redirected second light beam 207 are equally blocked by the obstruction 254, thereby eliminating the selective shadowing effects.

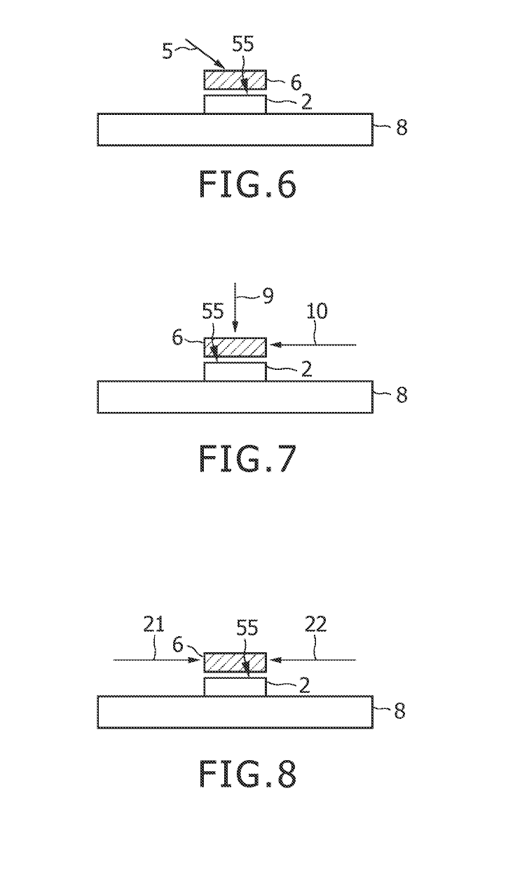

FIG. 3 schematically and exemplarily shows a lighting apparatus 1. The lighting apparatus 1 comprises a first light device 52 including a first light source 2 for generating a first light beam 3 and a light emanating element 6 from which the first light beam 3 emanates. The lighting apparatus 1 further comprises a second light device 53 comprising a second light source 4 for generating a second light beam 5. The first light device 52 and the second light device 53 are arranged to direct the second light beam 5 to the light emanating element 6 of the first light device 52 and the light emanating element 6 is adapted to redirect the second light beam 5 such that the redirected second light beam 7 emanates from the light emanating element 6. Since the first light beam 3 emanates from the emanating element 6 and since also the redirected second light beam 7 emanates from the light emanating element 6, both, the first light beam and the redirected second light beam, appear to originate from the same light emanating element, i.e. from the same location.

The light emanating element 6 is a part being separate from the first light source 2. The light emanating element 6 is located on an outer surface of the first light source 2, through which the first light beam 3 leaves the first light source 2. However, in another embodiment the light emanating element can also be a part of the first light source, for example, an outer part, in particular, an outer surface, of the first light source, through which the first light beam leaves the first light source, wherein this outer part, in particular, this outer surface, can be reflective for redirecting the second light beam. Further elements can be integrated into this outer part, in particular, into this outer surface, for further influencing the second light beam, for example, for diffusing, refracting, diffracting, et cetera, the second light beam. This integration can be performed by, for example, embossing and/or imprinting.

The first light source 2 is preferentially a light emitting diode and the second light source 4 is preferentially a laser. The first light device 52 further comprises a heatsink 8 for dissipating the heat generated by the first light source 2. The heatsink 8 is in thermal contact with the first light source, in order to allow the heatsink to dissipate the heat. The thermal contact can be achieved by directly contacting the first light source 2 and the heatsink 8, or by arranging the heatsink 8 and the first light source 2 such that the heat can radially be dissipated.

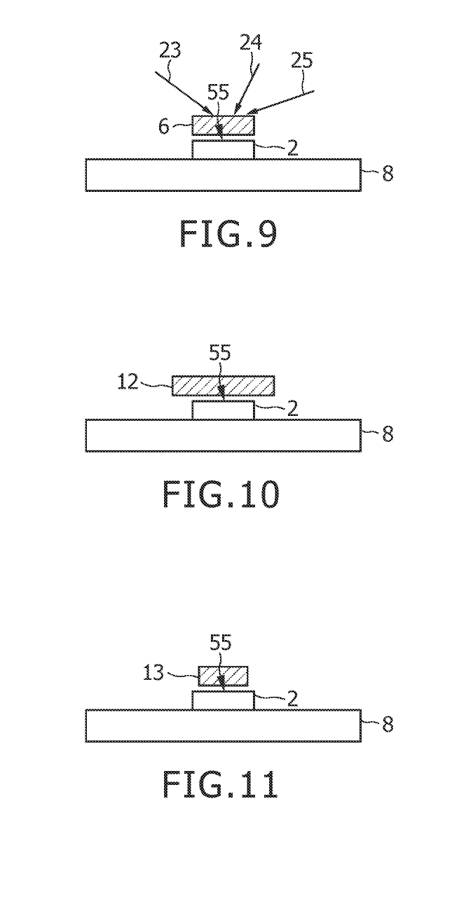

The outer part of the first light source 2 comprises an outer surface 55 through which the first light beam 3 leaves the first light source 2. The second light beam 5 can be oriented in different directions relative to this outer surface 55 as schematically and exemplarily illustrated in FIGS. 4-6. In FIG. 4, the second light beam is indicated by reference number 15 and perpendicular to the outer surface 55. In FIG. 5, the second light beam is indicated by reference number 16 and parallel to the outer surface 55, and in FIG. 6 the second light beam indicated by reference number 5 is transverse to the outer surface 55.

The light emanating element can be provided on the first light source with a gap between the first light source and the light emanating element or without such a gap.

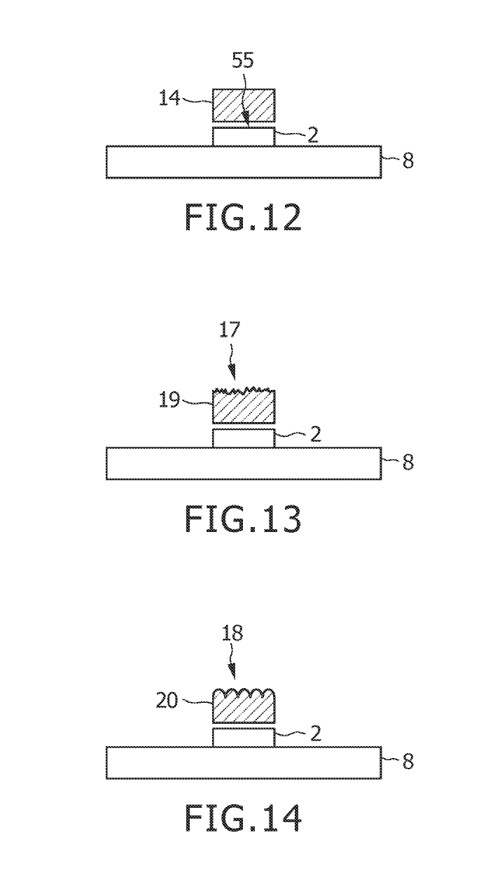

The second light device can be adapted to generate several second light beams for being directed to the light emanating element 6, wherein the light emanating element 6 is adapted to redirect the several second light beams such that the redirected several second light beams emanate from the light emanating element 6. The second light device can comprise one or several beam splitters and/or several second light sources like several lasers for generating several second light beams. The several second light beams can be directed to the light emanating element 6 in different directions as schematically and exemplarily shown in FIGS. 7 to 9. In FIG. 7, the second light beams 9, 10 are oriented perpendicular and parallel to the outer surface 55 of the first light source 2, respectively. In FIG. 8, the second light beams 21, 22 are oriented parallel to the outer surface 55 in opposing directions, and in FIG. 9 the second light beams 23, 24, 25 are directed to the light emanating element 6 in different transverse directions with respect to the outer surface 55 of the first light source 2.

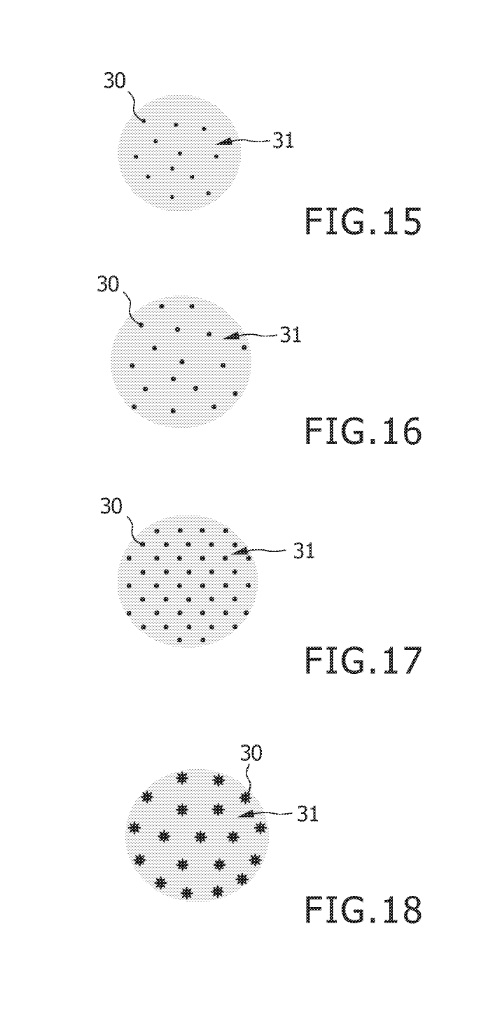

Although in FIGS. 3 to 9 the light emanating element 6 covers exactly the outer surface 55 and has substantially the same thickness as the first light source 2, the light emanating element can also have other dimensions as schematically and exemplarily shown in FIGS. 10 to 12. In FIG. 10, a light emanating element 12 is shown, which protrudes over the edges of the outer surface 55 of the first light source 2. In FIG. 11, the light emanating element 13 only covers a part of the outer surface 55 of the first light source 2, in particular, a central inner part. In FIG. 12, the light emanating element 14 has a thickness in a direction perpendicular to the outer surface 55 being larger than the corresponding thickness of the first light source 2.

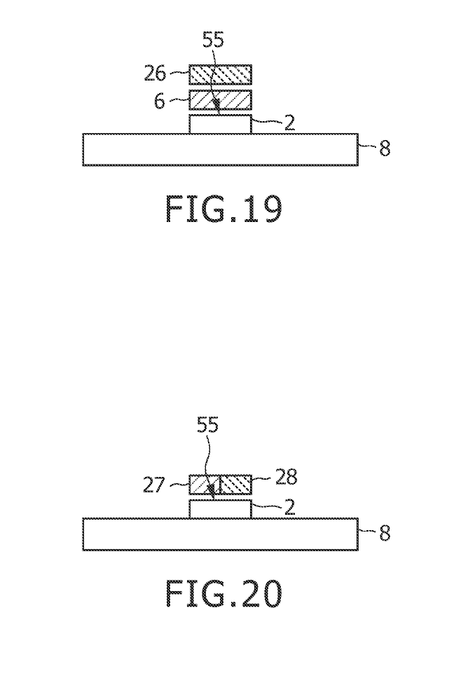

Although in FIGS. 3 to 12 the surfaces of the light emanating element are flat, at least one surface of the light emanating element can also have another shape as schematically and exemplarily illustrated in FIGS. 13 and 14. For example, the light emanating element 19 can comprise a rough surface 17 as schematically and exemplarily shown in FIG. 13 or the surface can have another shape, in particular, a periodic shape, as schematically and exemplarily shown in FIG. 14, in which a light emanating element 20 has a periodically shaped surface 18. The light emanating element can comprise a surface of any shape which is desired for generating certain illumination effects.

The light emanating element 6 can be adapted to redirect the second light beam in different ways such that the redirected second light beam 7 emanates from the light emanating element 6. For example, the light emanating element 6 can be adapted to redirect the second light beam 5 by reflecting the second light beam 5 such that the reflected second light beam 7 emanates from the light emanating element 6. The light emanating element 6 can be adapted to generate a reflection pattern by reflecting the second light beam 5, wherein this reflection pattern is, for example, a speckle pattern or can comprise light spots. The reflection pattern can be superimposed on illumination generated by the first light beam 3 for generating a combined illumination pattern. In addition or alternatively, the light emanating element can also be adapted to redirect the second light beam 5 by diffusing the second light beam 5 for generating a speckle pattern. Also this speckle pattern can be superimposed on the illumination generated by the first light beam 3 for generating a combined illumination pattern. Moreover, also in addition or alternatively, the light emanating element 6 can be adapted to redirect the second light beam 5 by diffracting the second light beam 5 for generating a diffraction pattern. Also this diffraction pattern can be superimposed on the illumination generated by the first light beam 3 for generating a combined illumination pattern. For example, a diffractive structure can be provided on the outer surface 56 of the light emanating element 6 met by the second light beam 5.

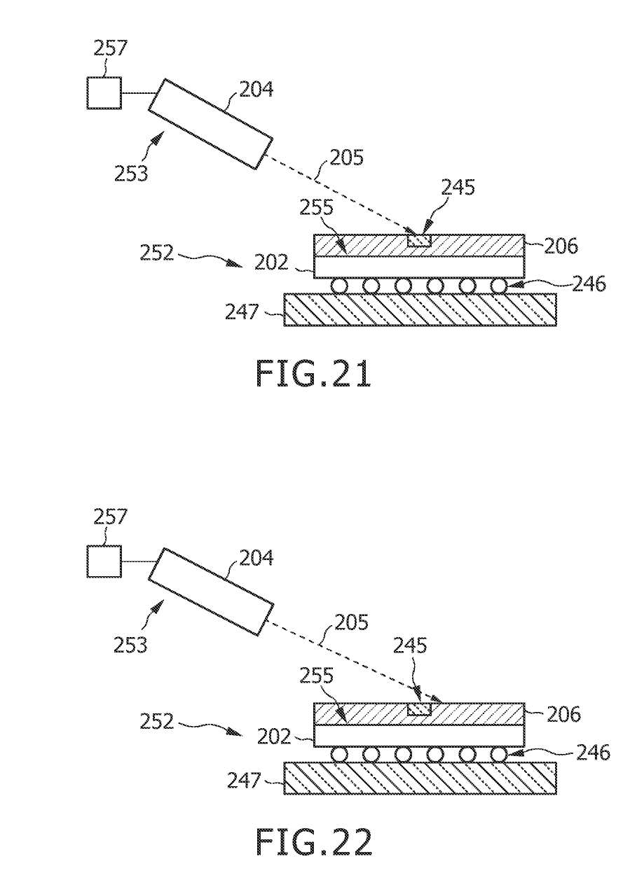

FIGS. 15 to 18 show schematically and exemplarily different illumination patterns, which have been generated by overlapping a light pattern generated by the redirected second light beam 7 and a background illumination generated by the first light beam 3. In these figures the background illumination is indicated by reference number 31 and light spots, in particular, laser sports, generated by the redirected second light beam are indicated by reference number 30. In FIGS. 15 to 17 different distributions of substantially circular light dots 30 superimposed on the background illumination 31 are shown. These light dots 30 can be distributed spacially homogenously or inhomogenously. The light dots 30 can also have another shape like a star-like shape which is schematically and exemplarily shown in FIG. 18. In particular, by adapting the diffractive properties of the light emanating element, a desired illumination pattern generated by the redirected second light beam, can be generated, in particular, with a specific spot design. Since the first light source is preferentially a light emitting diode and the second light source is preferentially a laser, high intensity spot effects superimposed on a background illumination can be generated by the hybrid lighting apparatus comprising the laser and the light emitting diode.

In an embodiment, the light emanating element is formed by an outer surface of the first light source, which is reflected for redirecting the second light beam such that it emanates from this outer surface. On this outer surface one or several optical elements can be provided for influencing the reflected second light beam such that a desired illumination pattern is generated. For example, this at least one optical element can be adapted to generate a desired illumination pattern by diffraction, diffusion, refraction, et cetera. This at least one optical element is preferentially located on the outer surface 55 of the first light source like the light emanating element 6 described above with reference to, for example, FIGS. 3 to 14. In particular, also this at least one optical element can have different sizes and differently structured surfaces. Moreover, also this at least one optical element can be adapted to generate the distributions and shapes of light dots shown in FIGS. 15 to 18.

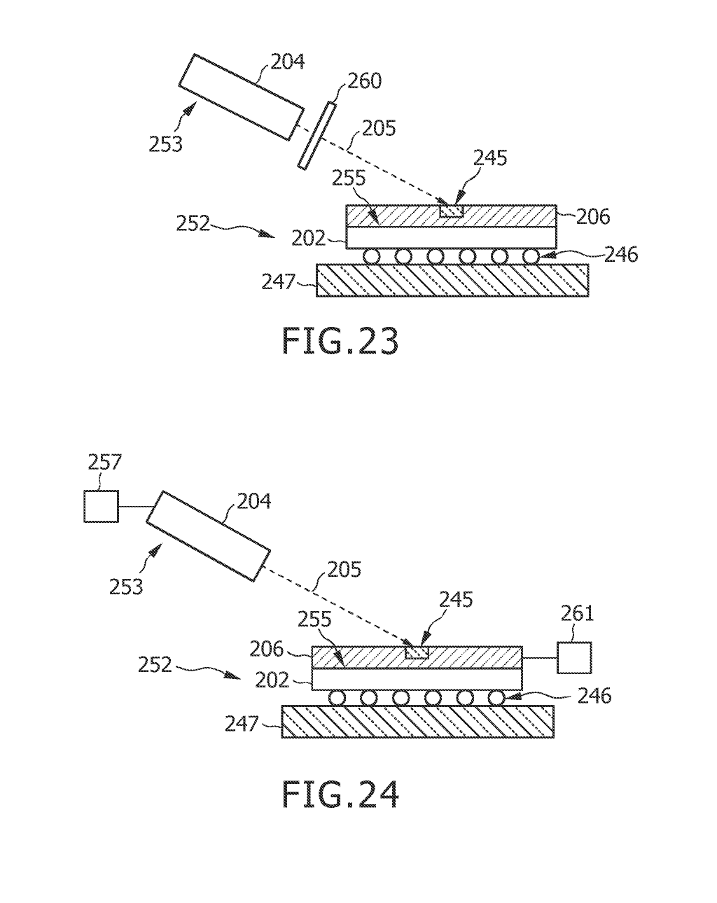

Instead of using only a single light emanating element 6 as schematically and exemplarily shown in FIG. 3, the first light device can also comprise multiple light emanating elements as schematically and exemplarily shown in FIGS. 19 and 20. The first light beam of the first light source 2 can traverse the multiple light emanating elements and the second light beam can be redirected by each of the multiple light emanating elements. In FIG. 19, two light emanating elements 6, 26 form a stack on the outer surface 55 of the first light source 2, through which the first light beam leaves the first light source 2 such that the first light beam traverses the stack of the light emanating elements 6, 26. At least one of the two light emanating elements 6, 26 is preferentially at least partly transparent to the second light beam, in order to allow the second light beam to be redirected by both light emanating elements 6, 26. In a further embodiment, schematically and exemplarily shown in FIG. 20, two light emanating elements 27, 28 are arranged side-by-side on the outer surface 55 of the first light source 2, through which the first light beam leaves the first light source 2 such that the first light beam traverses the light emanating elements 27, 28.

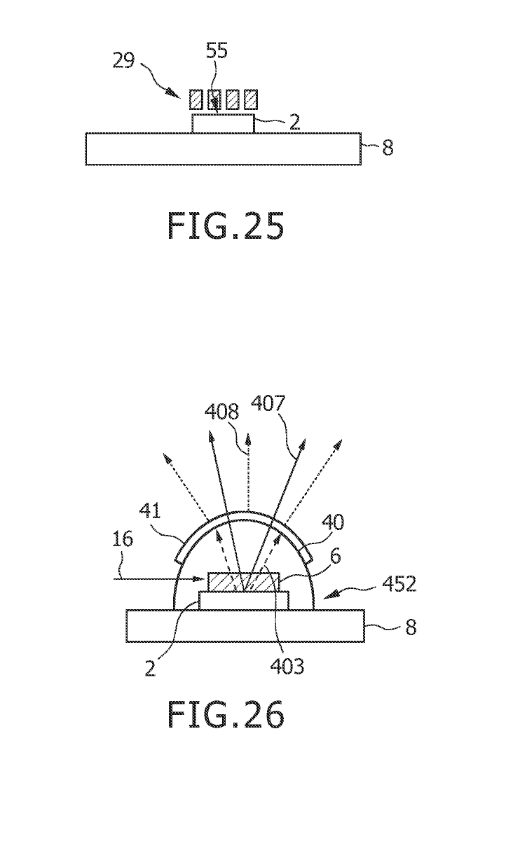

The different light emanating elements are preferentially adapted to influence the second light beam differently and the lighting apparatus is preferentially adapted to allow the second light beam to selectively be directed to a first light emanating element only, a second light emanating element only, or certain parts of both light emanating elements. This allows the lighting apparatus to modify the illumination pattern by modifying the illumination of the multiple light emanating elements by the second light beam. Such a kind of varying lighting effects is exemplarily and schematically also illustrated in FIGS. 21 and 22.

FIGS. 21 and 22 show the elements of an embodiment of the lighting apparatus needed for illustrating the modification of illumination effects caused by illuminating different light emanating elements. In FIG. 21, a first light device 252 comprises a first light source 202 being preferentially a light emitting diode, in particular, a thin film flip chip. The first light source 202 is connected to a substrate 247 being preferentially a ceramic substrate via bondings 246. A first light emanating element 206 is located on the outer surface 255 of the first light source 202 and a second light emanating element 245 is embedded in the first light emanating element 206 such that both, the first light emanating element 206 and the second light emanating element 245, can be illuminated by a second light beam 205 of a second light source 204 of a second light device 253. The second light device 253 further comprises a second light beam moving unit 257 for moving the second light beam 205 such that a desired light emanating element is illuminated. The second light beam moving unit 257 can be adapted to move the laser for moving the second light beam 205. However, it is also possible that the first light source 204 is not moved, but that only the direction of the second light beam 205 is modified by using, for example, a mirror. In FIG. 21, the second light beam 205 is directed to the second light emanating element 245, and in FIG. 22 the second light beam 205 is directed to the first light emanating element 206. The first and second light emanating elements 206, 245 influence the second light beam 205 differently. For example, the second light emanating element 245 can be a phosphor element for generating phosphor light as redirected second light beam if illuminated by the second light beam 205, and the first light emanating element 206 can be another kind of light emanating element. For example, the first light emanating element 206 can be adapted to influence the second light beam by reflection, diffraction, diffusion, refraction, converting the second light beam to a color being different to the color of the phosphor light generated by the second light emanating element 245, et cetera.

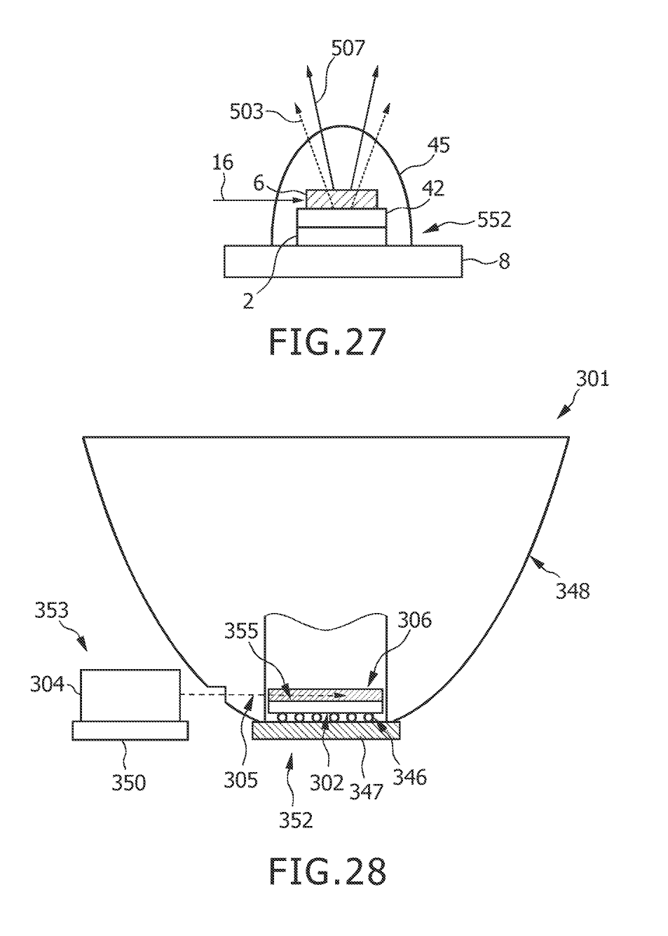

The second light device 253 can comprise a redirection element 260 not being the one or several light emanating elements 206, 245 as schematically and exemplarily shown in FIG. 23. The redirection element 260 is adapted for selectively directing the second light beam 205 to one or several of the multiple light emanating elements 206, 245. In another embodiment, in addition or alternatively another optical element can be used for manipulating the second light beam 205. For example, the optical element can be adapted to modify the polarization, intensity, et cetera of the second light beam 205. The redirection element 260 and/or the optical element can be adapted to modify speckle patterns, diffraction patterns, colors, if at least a part or one of the light emanating elements comprises a phosphor, et cetera. The optical element is preferentially an electro-optical element. The optical element is, for example, a polymer dispersed liquid crystal (PDLC) element, a cholesteric liquid crystal element, a liquid crystal gel element, a gradient index liquid crystal element, an electro-phoretic element, an electro-wetting element, et cetera.

For selectively directing the second light beam 205 to the one or several of the multiple light emanating elements 206, 245, in addition or alternatively, the one or several light emanating elements 206, 245 can be moved as schematically and exemplarily shown in FIG. 24. The first light device 252 can comprise a moving unit 261 for moving the multiple light emanating elements 206, 245 with respect to the second light beam 205. The moving unit 261 can be adapted to move the complete first light device 252 with respect to the second light beam 205. The moving unit can also be adapted to move only a part of the first light device 252, in particular, only the light emanating elements, with respect to the second light beam 205. The moving unit 261 can comprise a piezoelectric element being in contact with the first light device 252 for moving the light emanating elements with respect to the second light beam.

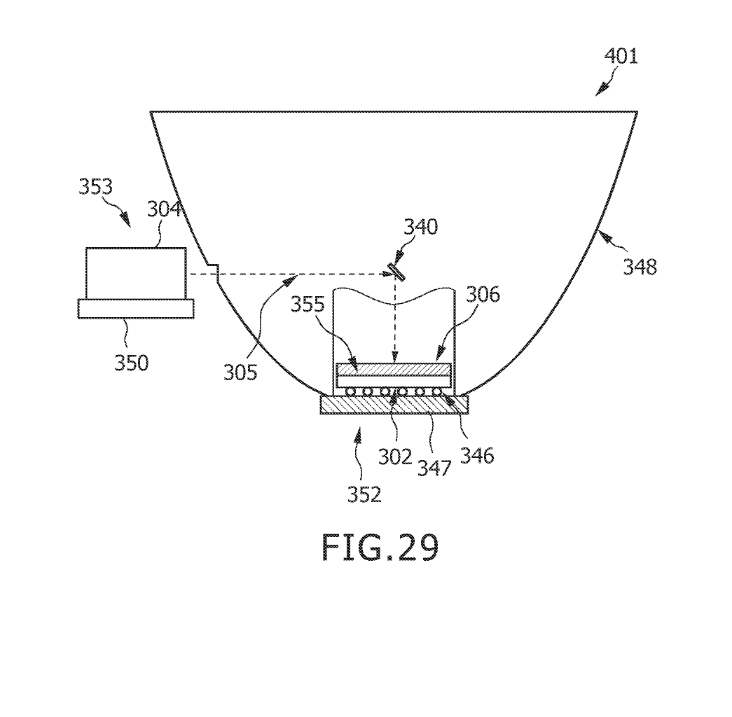

The light emanating element can also be structured. This is schematically and exemplarily shown in FIG. 25 in which a structured light emanating element 29 is located on the outer surface 55 of the first light source 2, through which the first light beam leaves the first light source 2.

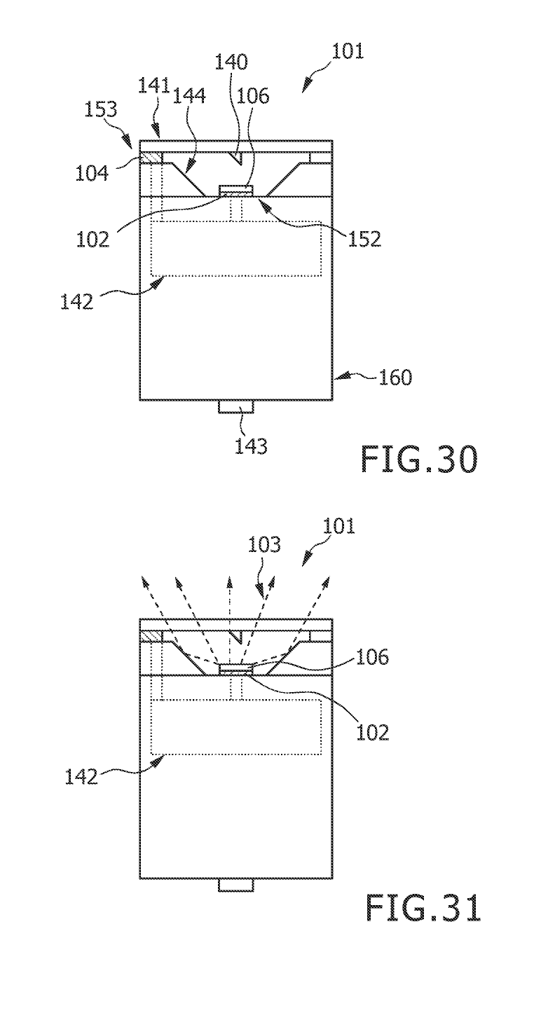

FIG. 26 shows schematically and exemplarily a further embodiment of a lighting apparatus. A first light device 452 comprises a first light source 2 for generating a first light beam 403 and a light emanating element 6 from which the first light beam 403 emanates. A second light device comprises a second light source (not shown in FIG. 26) for generating a second light beam 16. The second light beam 16 is directed to the light emanating element 6 of the first light device 452, wherein the light emanating element 6 is adapted to redirect the second light beam 16 such that the redirected second light beam 407 emanates from the light emanating element 6. The first light device 452 further comprises a transparent cover 40 enclosing the light emanating element 6 and the first light source 2. On the outside of the cover 40 a phosphor layer 41 is provided for converting the first light beam 403 to converted light 408. Also the phosphor layer 41 could be regarded as a light emanating element. The phosphor layer 41 can also be provided on an inner surface of the transparent cover 40.

FIG. 27 shows schematically and exemplarily a further embodiment of a lighting apparatus. A first light device 552 comprises a combination of a first light source 2 and a phosphor layer 42 for generating a first light beam 503. The first light device 552 further comprises a light emanating element 6 from which the first light beam 503 emanates. A second light device comprising a second light source (not shown in FIG. 27) generates a second light beam 16 which is directed to the light emanating element 6 of the first light device 552, wherein the light emanating element 6 is adapted to redirect the second light beam 16 such that the redirected second light beam 507 emanates from the light emanating element 6. Also in this embodiment the first light device 552 comprises a transparent cover 45.

The transparent covers 40, 45 shown in FIGS. 26 and 27 can have any desired shape. For example, the transparent covers can have a spherical or elliptical shape.

In FIGS. 26 and 27 the first light source 2 is preferentially a blue light emitting diode, wherein the phosphor is adapted to convert the blue light into white light. For generating a desired illumination pattern, a diffractive element can be placed on the respective phosphor layer.

FIG. 28 shows a further embodiment of a lighting apparatus. The lighting apparatus 301 comprises a first light device 352 comprising a first light source 302 being a light emitting diode, in particular, a thin film flip chip light emitting diode. The first light source 302 is bonded to a substrate 347 being preferentially a ceramic substrate via bondings 346. A light emanating element 306 is located on an outer surface 355 of the first light source 302. The light emanating element 306 is adapted to redirect a second light beam 305 such that the redirected second light beam 305 emanates from the light emanating element 306. The second light beam 305 is generated by a second light source 304 of a second light device 353. The second light source 304 is preferentially a laser. The second light device 353 further comprises a heatsink for dissipating the heat generated by the second light source 304 and/or a substrate 350. The light emanating from the light emanating element 306 is preferentially collimated by a collimator 348. Instead of using a collimator also a reflector can be used.

In FIG. 28, the first light device 352 and the second light device 353 are arranged such that the second light beam 305 is oriented parallel to the outer surface 355 of the first light source 302.

FIG. 29 shows schematically and exemplarily a further embodiment of a lighting apparatus 401, which is substantially similar to the lighting apparatus 301 described above with reference to FIG. 28. The only difference is the redirection element 340, which is preferentially a mirror for allowing the second light beam 305 to meet the light emanating element 306 in an orientation which is perpendicular to the outer surface 355 of the first light source 302.

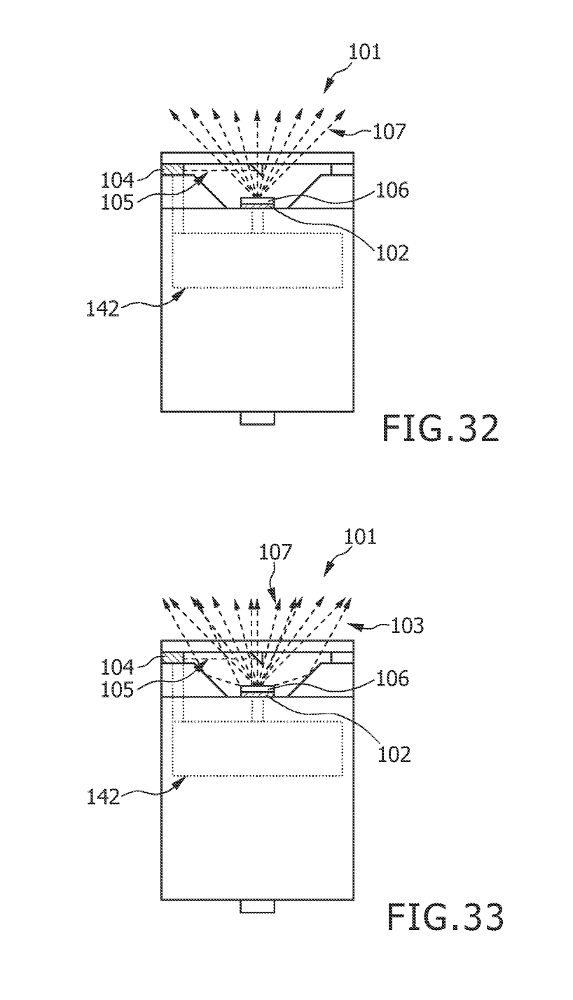

FIGS. 30 to 33 show schematically and exemplarily a further embodiment of the lighting apparatus being a retrofit lamp which may be used in, for example, torches, toys or luminaires.

The lighting apparatus 101 shown in FIGS. 30 to 33 comprise a first light device 152 with a first light source 102 and a light emanating element 106. The lighting apparatus 101 further comprises a second light device 153 with a second light source 104. The first light source 102 and the second light source 104 are connected to a switching circuit 142 for switching the first light source 102 and the second light source 104. Also in this embodiment, the first light source is preferentially a light emitting diode and the second light source is preferentially a laser. The lighting apparatus 101 comprises a casing 160 with a transparent element 141 for allowing light generated within the casing 160 to leave the casing 160. The casing 160 further comprises a reflecting inner conical surface 144 for directing the generated light to the transparent element 141. A redirection element 140, in particular, a mirror 140, is provided for allowing a second light beam generated by the second light source 104 to be directed onto the light emanating element 106.

In FIG. 30 the first light source 104 and the second light source 104 are switched off and light is not generated. In FIG. 31, only the first light source 102 is switched on by using the switching circuit 142, thereby generating the first light beam 103. In FIG. 32, only the second light source 104 is switched on by using the switching circuit 142 such that a second light beam 104 is directed to the light emanating element 106 for redirecting the second light beam such that the redirected second light beam 107 emanates from the light emanating element 106. In FIG. 33, the first light source 102 and the second light source 104 are switched on by using the switching circuit 142. An object can therefore be illuminated by a combination of the first light beam generated by the first light source and the redirected second light beam 107 generated by directing the second light beam 105 to the light emanating element 106.

The lighting apparatus 101 preferentially comprises an input unit like a button being connected to the switching circuit 142 for allowing the user to switch the first light source and the second light source selectively on and off.

The lighting apparatus 101 further comprises an electrical contact 143 for electrically connecting the lighting apparatus to a power source of, for example, a torch, a toy or a luminaire. Also the outer part of the casing 160 is preferentially adapted to electrically contact a power source for powering the lighting apparatus.

In all of the above described embodiments the light emanating element is preferentially adapted to allow the first light beam to traverse the light emanating element such that the first light beam, which has traversed the light emanating element, and the redirected second light beam, appear to originate from the same light emanating element, i.e. from the same location.

Although in the above described embodiments, which have been described with reference to the figures, a light emanating element is located on an outer surface of the first light source, through which the first light beam leaves the first light source, wherein this light emanating element redirects the second light beam such that the first light beam and the second light beam appear to originate from the same light emanating element, is also possible that the light emanating element is integrated in the first light source. For example, the outer surface of the first light source, through which the first light beam leaves the first light source, can be reflective to the second light beam such that this outer surface is an integrated light emanating element, because the first light beam traverses this outer surface and the second light beam is reflected by this outer surface such that the first light beam and the reflected second light beam appear to originate from the same light emanating element being the outer surface of the first light source. In this case, further optical elements, which can be provided in the optical path of the reflected second laser beam, do not have to redirect the reflected second light beam. However, these optical elements can also influence the reflected second light beam, for example, by diffraction, refraction, diffusion, et cetera, while traversing the optical elements, for generating desired illumination patterns like the illumination patterns exemplarily and schematically shown in FIGS. 15 to 18. These optical elements can be sized, structured and arranged on the outer surface of the first light source as described above for the light emanating element with reference to FIGS. 3 to 14 and 19 to 33. The lighting apparatus comprises at least one light emanating element being adapted to redirect the second light beam such that the redirected second light beam and the first light beam emanate from the same light emanating element, wherein this light emanating element can be a part of the first light source, for example, an outer part with an outer surface, through which the first light beam leaves the first light source, or this light emanating element can be a separate part being preferentially arranged on this outer surface of the first light source. In addition, the lighting apparatus can comprise further optical elements like the above described optical elements for influencing the redirected second light beam.

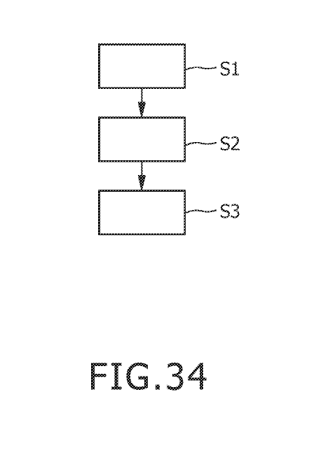

In the following a lighting method will exemplarily described with reference to a flowchart shown in FIG. 34.

In step S1, a first light beam 3 is generated by the first light source 2 of the first light device 52, wherein the first light device 52 comprises the light emanating element 6 from which the first light beam 3 emanates. In step S2, a second light beam 5 is generated by the second light source 4 of the second light device 53, and in step S3 the second light beam 5 is directed to the light emanating element 6 of the first light device 52, wherein the light emanating element 6 redirects the second light beam 5 such that the redirected second light beam 7 emanates from the light emanating element 6.

It should be noted that the sequence of steps S1 to S3 can be modified, in particular, these steps can be performed simultaneously. For example, the first light beam can be generated before the second light beam is generated, the second light beam can be generated before the first light beam is generated and both, the first light beam and the second light beam, can be generated simultaneously. Moreover, after the second light beam has been generated, the generation of the second light beam can continue and at the same time the second light beam is directed to the light emanating element.

The lighting apparatus is preferentially adapted to be used in decorative lighting, shop-lighting and atmosphere creation.

The light emanating element can comprise a phosphor for converting the first light beam and the second light beam or the redirected second light beam into phosphor light. The first light beam is preferentially a beam of a light emitting diode and the second light beam is preferentially a beam of a laser. The laser and the light emitting diode are preferentially pulse-width modulated for controlling the color of the lighting apparatus comprising the phosphor. Preferentially, the laser and the light emitting diode emit light in different parts of the spectrum, wherein both, the light of the laser and the light of the light emitting diode, can be converted by the phosphor. The light emanating element can be comprised of two phosphor layers arranged like the layers 6 and 26 shown in FIG. 19.

The light emanating element can be an electrically switchable element, for example, a polymer dispersed liquid crystal (PDLC) element, a cholesteric liquid crystal element, a liquid crystal gel element, a gradient index liquid crystal element, an electro-phoretic element, or an electro-wetting element. Such an electrically switchable element may also comprise a light conversion component such as a luminescent material. By switching this light emanating element the magnitude of color conversion may be adjusted. In the same way the characteristics of the beams like the direction and/or collimation may be controlled.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

The control of the lighting apparatus in accordance with the lighting method can be implemented as program code means of a computer program and/or as dedicated hardware.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

The invention relates to a lighting apparatus. A first light device comprises a first light source for generating a first light beam and a light emanating element from which the first light beam emanates. A second light device with a second light source generates a second light beam being directed to the light emanating element of the first light device, wherein the light emanating element is adapted to redirect the second light beam such that the redirected second light beam emanates from the light emanating element. Since the first light beam and the redirected second light beam emanate from the light emanating element, both light beams appear to originate from the same location. The probability of generating selective shadowing effects can therefore be reduced, in particular, selective shadowing effects can be eliminated.

1. A lighting apparatus comprising:
a first light device comprising a first light source for generating a first light beam and a light emanating element from which the first light beam emanates,
a second light device comprising a second light source for generating a second light beam,
wherein the first light device and the second light device are arranged to direct the second light beam to the light emanating element of the first light device wherein the light emanating element is adapted to redirect the second light beam such that the redirected second light beam emanates from the light emanating element.

2. The lighting apparatus as defined in claim 1, wherein the first light source is a light emitting diode and the second light source is a laser.

3. The lighting apparatus as defined in claim 1, wherein the light emanating element is adapted to redirect the second light beam by reflecting the second light beam such that the reflected second light beam emanates from the light emanating element.

4. The lighting apparatus as defined in claim 3, wherein the light emanating element is adapted to redirect the second light beam by reflecting the second light beam for generating a reflection pattern.

5. The light apparatus as defined in claim 1, wherein the light emanating element is adapted to redirect the second light beam by diffusing the second light beam for generating a speckle pattern.

6. The lighting apparatus as defined in claim 1, wherein the light emanating element is adapted to redirect the second light beam by diffracting the second light beam for generating a diffraction pattern.

7. The lighting apparatus as defined in claim 1, wherein the light emanating element is adapted to redirect the second light beam by converting the second light beam into a third light beam having a color being different to the color of the second light beam, wherein the third light beam emanates from the light emanating element.

8. The lighting apparatus as defined in claim 1, wherein the second light device is adapted to generate several second light beams, for being directed to the light emanating element, wherein the light emanating element is adapted to redirect the several second light beams such that the redirected several second light beams emanate from the light emanating element.

9. The lighting apparatus as defined in claim 1, wherein the first light device comprises multiple light emanating elements wherein the first light device and the second light device are arranged to allow the first light beam to traverse the multiple light emanating elements and to allow the second light beam to be redirected by the multiple light emanating elements.

10. The lighting apparatus as defined in claim 1, wherein the first light device comprises multiple light emanating elements wherein the first light device and the second light device are adapted to allow the first light beam to traverse the multiple light emanating elements and to allow the second light beam to be selectively directed to one or several of the multiple light emanating elements.

11. The lighting apparatus as defined in claim 10, wherein the second light device comprises a redirection element for selectively directing the second light beam to the one or several of the multiple light emanating elements.

12. The lighting apparatus as defined in claim 10, wherein the first light device is adapted to move the one or several of the multiple light emanating elements with respect to the second light beam such that the second light beam is selectively directable to the one or several of the multiple light emanating elements.

13. The lighting apparatus as defined in claim 1, wherein the lighting apparatus comprises a switch for switching at least one of the first light device and the second light device.

14. A lighting method comprising:
generating a first light beam by a first light source of a first light device comprising a light emanating element from which the first light beam emanates,
generating a second light beam by a second light source of a second light device,
directing the second light beam to the light emanating element of the first light device, wherein the light emanating element redirects the second light beam such that the redirected second light beam emanates from the light emanating element.
